(19) United States
(12) Patent Application Publication
(10) Pub. No.: US 2023/0072143 A1
(43) Pub. Date: Mar. 9, 2023

(54) COMPACT MASK FOLDING AND WELDING MECHANISM

(71) Applicant: Synkron Biosciences Corporation, Sarasota, FL (US)

(72) Inventor: Joseph A. Bobier, Berea, WV (US)

(21) Appl. No.: 17/941,071

(22) Filed: Sep. 9, 2022

Related U.S. Application Data
(60) Provisional application No. 63/240,403, filed on Sep. 3, 2021.

(51) Int. Cl. A41D 27/24; A41D 13/11; A41H 43/02

(52) U.S. Cl. CPC A41D 27/245; A41D 13/11; A41H 43/0257

(57) ABSTRACT

A compact, on-demand mask folding and welding system which reduces the size, cost, noise hazard and complexity of the folding and welding process used in the manufacture of medical and protective face masks is disclosed.

### CROSS-REFERENCE TO RELATED APPLICATION

The present application claims the benefit of previously filed co-pending Provisional Patent Application, Ser. No. 63/242,075 filed on Sep. 9, 2021.

### FIELD OF THE INVENTION

The device of this disclosure is a compact folding and welding mechanism used in the manufacture of medical and protective face masks.

### BACKGROUND OF THE INVENTION

The current state of the art in the field of folding and welding together of protective and medical face masks, generally requires the use of a substantially large and bulky set of machinery which convey partially manufactured masks on a fabric web along a route of processes that use high pressure sequences of rollers and rotary ultrasonic welding presses to fold and weld together a seam on multiple layers of non-woven polymer fabric. The folding and welding operation is a necessary step which gives the mask a three-dimensional, face forming shape. Such machinery is large, heavy, power hungry and subject to very precise positional calibration to maintain a wrinkle free and well-formed mask. Such operations usually involve machinery weighing hundreds of pounds and occupying floor space of 100 square feet or more.

The compact mask folding and welding mechanism disclosed herein eliminates all of the ultrasonic presses, the fabric web, the weight, noise hazards, and bulk of traditional mechanisms, replacing it with a compact assembly. The disclosed mechanism could easily fit in an on-demand medical and protective mask making vending system such as the one invented by the inventor of this application, disclosed in U.S. application Ser. No. 17/902,041 filed on Sep. 2, 2022, and incorporated herein.

### BRIEF SUMMARY OF THE INVENTION

The invention can fold and weld protective and medical face masks in a very small mechanism that can be used as part of a compact, on-demand mask manufacturing machine.

### BRIEF DESCRIPTION OF THE DRAWINGS

For a fuller understanding of the nature and objects of the invention, reference should be made to the following detailed description, taken in connection with the accompanying drawing, in which:

FIG. 1 shows a front view diagram of a preferred embodiment of the invention.

### DESCRIPTION OF THE PREFERRED EMBODIMENT

During the currently known prior art process of manufacturing face masks, one or more layers of fabric will be partially constructed while in a flat shape. However, in the finished form, face masks are generally folded in half and a seam is welded along one edge to change the finished mask into the familiar cup shape which fits the face. During a typical prior art manufacturing process therefore, steps are necessary to fold the mask and form the closing seam. Typically, these steps are done by folding the mask in a continuous process while it is still attached to a continuous roll of fabric. This continuous roll of fabric is known as the “web” and until the mask is cut out of the roll of fabric, the web acts as a carrier, pulling the masks though the mechanized processes that build various parts of the mask. In this prior art continuous process cutting the finished mask out of the web is the final step.

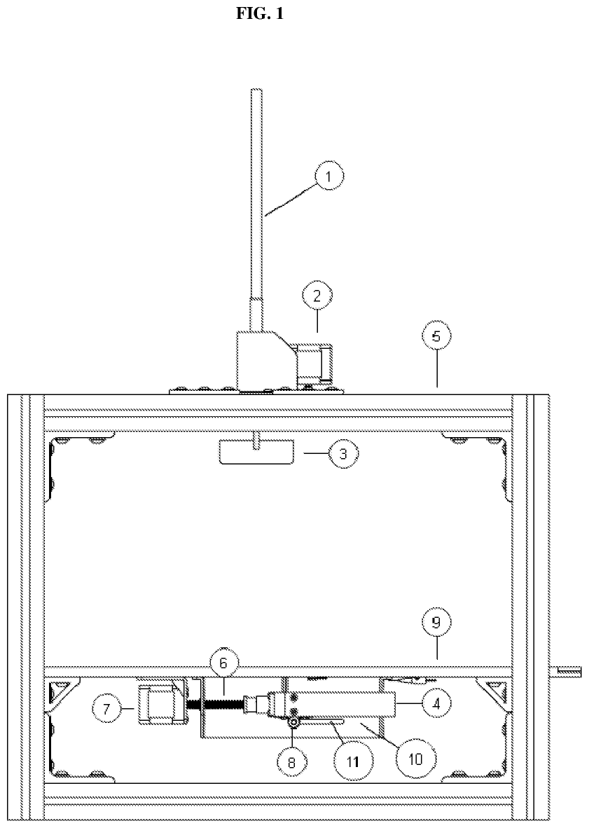

The preferred embodiment of this disclosure, as shown from a front view in FIG. 1, is a compact face mask folding and laser welding system. The invention of this disclosure fundamentally changes the manufacturing process in that the masks are cut out of the web before the folding and welding of the final seam.

The preferred embodiment shown from the front in FIG. 1 is comprised of the following elements. Element 1 depicts a pinion rod (1), comprised of a rod with gear teeth. Element 2 depicts a stepper motor (2) with a pinion drive gear (not shown), which engages the pinion rod (1). Element 3 depicts a paddle (3), which is flat and is attached to the pinion rod (2). Element 4 depicts a connector plate (4), which is attached to a worm gear (6) and a laser lens (8) which is identical to a second laser lens (not shown) on the opposite side of the connector plate (4). Element 7 depicts a stepper motor (7) which turns worm gear (6). Element 5 depicts the frame (5) of the machine. Element 9 depicts a platen (9), which is comprised of a metal plate upon which the fabric (not shown) will rest while various processes are carried out to facilitate manufacture of the mask. Element 10 depicts a pair of parallel springed together plates (10), which are connected to the bottom of platen (9) and between which paddle (3) will push the folded mask fabric. Element 11 depicts a slot (11) through which the passing fabric will be visible and through which lasers (8) will weld the leading edge of the fabric.

Specifically, the preferred embodiment manufacturing process comprises once the mask has been cut from the web it now rests on the platen (9) in a loose fashion. Paddle (3) is driven downward by stepper motor (2) and will meet the loose mask exactly at its vertical center. Paddle (3) will push the mask downward through a slot in platen (9), thereby causing the mask to fold along its center line. As the mask is folded and pushed down, it is forced between the two springed together plates (10) which forcibly compress the two halves of the mask together. While the mask is moving downward between the springed together plates (10), the leading edge of the mask that is to be welded together forming the final seam, will pass by slot (11) through which the mask fabric is visible. Laser (8) and its identical twin on the opposite side of the connector plate (4) are moved horizontally and energized so the laser output is directed at the leading edge of the mask as it passes across the slot. When the lasers have reached the end of the slot, the lasers are de-energized and stepper motor (7) reverses, thus retracting the lasers to starting position. The mask will continue to travel downward between the springed together plates (10) and ultimately pass out the bottom of the machine. Paddle (3) will retract by the reversal of stepper motor (2) to its starting position.

Other embodiments are obvious to the inventor which could customize the invention to meet the needs of faster or slower production.

In the preferred embodiment of this disclosure medical and protective masks are generally defined by the N-95 design and standards but could be produced to meet any standard, with single or multiple layers of fabric.

Since certain changes may be made in the above-described system of a compact mask folding and welding system without departing from the scope of the invention herein involved, it is intended that all matter contained in the description thereof shall be interpreted as illustrative and not in a limiting sense.

What is claimed is:

1. A mask manufacturing system in that a fabric mask is cut out of a fabric web before the folding and welding of a final mask seam comprising:
a pinion rod comprised of a rod with gear teeth running the length of said pinion rod;
a stepper motor with a pinion drive gear which engages said pinion rod gear teeth;
a folding paddle which is flat and is attached to an end of said pinion rod;
a connector plate which is attached to a worm gear;
a laser lens on one side of said connector plate;
an identical second laser lens on the opposite side of said connector plate;
a stepper motor which turns said worm gear wherein moving said connector plate and both of said laser lens;
a frame of said mask manufacturing system;
a platen which is comprised of a metal plate upon which said fabric mask will rest while various processes are carried out to facilitate manufacture of said fabric mask;
a folding slot in said platen aligned with said folding paddle wherein said folding paddle pushes a piece of cut fabric laying on said platen through said folding slot such that said cut fabric is folded in half as it is pushed through said folding slot;
a pair of parallel springed together plates connected to the bottom of said platen and parallel to said folding slot and between which said paddle will push said folded mask fabric; and,
a welding slot in said parallel springed together plates through which said passing folded fabric mask will be visible and through which each of said moving laser lens will weld the leading edge of said folded fabric mask.
